(19) United States
(12) Patent Application Publication
(10) Pub. No.: US 2012/0167684 A1
(43) Pub. Date: Jul. 5, 2012

(54) SELECTIVE MOTION RECOGNITION APPARATUS USING INERTIAL SENSOR

(75) Inventors: Byoung Won HWANG, Gyunggi-do (KR); Ho Seop JEONG, Gyunggi-do (KR); Jung Won LEE, Seoul (KR)

(73) Assignee: SAMSUNG ELECTRO-MECHANICS CO., LTD., Gyunggi-do (KR)

(21) Appl. No.: 13/316,392

(22) Filed: Dec. 9, 2011

(30) Foreign Application Priority Data
Dec. 31, 2010 (KR) 10-2010-0139979

(51) Int. Cl. G01P 3/04

(52) U.S. Cl. 73/510

(57) ABSTRACT

Disclosed herein is a selective motion recognition apparatus using an inertial sensor. The selective motion recognition apparatus using an inertial sensor includes: an sensor unit; a selection unit that outputs a sensor selection signal; and a motion detection unit that receives an angular velocity sensor data and an acceleration sensor data output from the sensor unit.

### CROSS REFERENCE TO RELATED APPLICATION

This application claims the benefit of Korean Patent Application No. 10-2010-0139979, filed on Dec. 31, 2010, entitled “Selective Motion Recognition Apparatus Using Inertial Sensor” which is hereby incorporated by reference in its entirety into this application.

### BACKGROUND OF THE INVENTION

1. Technical Field

The present invention relates to a selective motion recognition apparatus using an inertial sensor.

2. Description of the Related Art

An inertial sensor is to represent an inertial force as a deformation of an elastic structure connected to a mass body generated by acceleration or angular velocity and then, the deformation of the structure as an electrical signal using an appropriate sensing and signal processing mechanism.

Since the 1990s, the inertial sensor has been microminiaturized and mass produced in order to be implemented with the development of micro-electromechanical systems using a semiconductor process.

The inertial sensor, which is largely classified into an acceleration sensor and an angular velocity sensor, is applied to various applications in addition to controlling a position and posture of a ubiquitous robotic companion (URC). Currently, the inertial sensor has been in the limelight for applications such as, in particular, a suspension system, a brake integrated control, an airbag, and a car navigation system, etc.

The inertial sensor may also be applied to a data input device of a portable information device such as a portable navigation system, a wearable computer, a PDA, etc., which are applied to a mobile communication complex terminal.

Recently, the inertial sensor has been applied to a mobile phone to implement continuous motion recognition and a three-dimensional game, in which these products have been sold.

As described above, the inertial sensor may be used as the input device of the portable terminal, which may be implemented by installing the inertial sensor in the portable terminal or connecting a separate input device, or the inertial sensor is installed to a portable terminal.

In this case, a user may use the motion of the inertial sensor in order to perform specific functions using corresponding data generated by the inertial sensor for functions provided in the portable terminal.

Meanwhile, the motion recognition apparatus using the inertial sensor is configured to include a setting unit that sets a threshold value and a period and a determination unit that determines a motion by comparing sensing data received from the inertial sensor with the threshold value and checking the period.

As a result, the motion recognition apparatus according to the prior art can implement fragmentary motion recognition but has a limitation in recognizing and determining various motions.

That is, the motion recognition apparatus according to the prior art can individually recognize acceleration or angular velocity but is difficult to provide complex motion recognition for a coupling relationship of the angular velocity with the acceleration and a coupling relationship of the angular velocity and a direction or a coupling relationship of the acceleration and a direction, etc.

### SUMMARY OF THE INVENTION

The present invention has been made in an effort to provide a selective motion recognition apparatus using an inertial sensor capable of performing complex motion recognition by detecting unit motions using sensor data and set parameters and combining the detected unit motions.

According to a preferred embodiment to the present invention, a selective motion recognition apparatus using an inertial sensor includes: an sensor unit that includes an angular velocity sensor to measure angular velocity and output angular velocity sensor data and includes an acceleration sensor to measure acceleration and output acceleration sensor data; a selection unit that outputs a sensor selection signal selecting any one of the angular velocity sensor, the acceleration sensor, and a combination of the angular velocity sensor and the acceleration sensor; and a motion detection unit that receives the angular velocity sensor data and the acceleration sensor data output from the sensor unit to output any one of the angular velocity sensor data, the acceleration sensor data, and a combination of the angular velocity sensor data and the acceleration sensor data according to the sensor selection signal of the selection unit.

The angular velocity sensor of the sensor unit may output the angular velocity sensor data for each axis by measuring the angular velocity for each axis of multi-axis and the acceleration sensor of the sensor unit may output the acceleration sensor data for each axis by measuring the acceleration for each axis of multi-axis, the selection unit may output an axis selection signal selecting an axis of multi-axis of each of the angular velocity sensor and the acceleration sensor, and the motion detection unit may receive the angular velocity sensor data for each axis and the acceleration sensor data for each axis output from the sensor unit to output any one of the angular velocity sensor data for each axis, the acceleration sensor data for each axis, and a combination of the angular velocity sensor data for each axis and the acceleration sensor data for each axis according to the axis selection signal input from the selection unit.

The selection unit may include a sensor type selection end including a selection switch for each sensor type to output a sensor selection signal selecting the sensor type; and an axis type selection end including an axis type selection switch for each sensor type to output the axis selection signal selecting the axis type for the sensor selected in the sensor type selection end.

The selection unit may include an axis selection AND circuit for each of a plurality of sensor types including a sensor enable signal input end receiving a sensor enable signal and an axis enable signal input end receiving an axis selection enable signal selecting the axis type for each sensor type to output the axis selection signal for each sensor.

The sensor unit may include an earth magnetic field sensor to measure an earth magnetic field and output the earth magnetic field sensor data, the selection unit may output the sensor selection signal selecting any one of the angular velocity sensor, the acceleration sensor, the earth magnetic field sensor, and a combination thereof to the angular velocity sensor, the acceleration sensor, and the earth magnetic field sensor, and the motion detection unit may receive the angular velocity sensor data, the acceleration sensor data, and the earth magnetic field sensor output from the sensor unit to output any one of the angular velocity sensor data, the acceleration sensor data, the earth magnetic field sensor data, and a combination thereof according to the sensor selection signal of the selection unit.

The earth magnetic field sensor of the sensor unit may measure the earth magnetic field for each axis of multi-axis to output the earth magnetic field sensor data for each axis, the selection unit may output the axis selection signal selecting the axis of multi-axis of each of the angular velocity sensor, the acceleration sensor, and the earth magnetic field sensor, and the motion detection unit may receive the angular velocity sensor data for each axis, the acceleration sensor data for each axis, and the earth magnetic field sensor data for each axis output from the sensor unit to output any one of the angular velocity sensor data for each axis, the acceleration sensor data for each axis, the earth magnetic field sensor data for each axis, and a combination of the angular velocity sensor data for each axis, the acceleration sensor data for each axis and the earth magnetic field sensor data for each axis according to the axis selection signal input from the selection unit.

The selective motion recognition apparatus using an inertial sensor may further include a determination unit that receives any one of the angular velocity sensor data, the acceleration sensor data, and a combination of the angular velocity sensor data and the acceleration sensor data output from the motion detection unit to recognize and output the complex motion.

The determination unit may include a first combiner receiving and primarily combining any one of the angular velocity sensor data, the acceleration sensor data, and a combination of the angular velocity sensor data and the acceleration sensor data detected and output in the motion detection unit to generate and output a primary complex motion signal; and a second combiner secondarily combining the output of the first combiner to generate and output the secondary complex motion signal.

The angular velocity sensor may include an angular velocity sensor element measuring and outputting the angular velocity when a driving signal is input; a driving circuit unit outputting the driving signal for driving the angular velocity sensor element; a first detection circuit unit detecting and outputting an output signal from the angular velocity sensor element; and a first processing circuit unit extracting and outputting the angular velocity sensor data from the output signal when the output signal from the first detection circuit is input.

The acceleration sensor may include: an acceleration sensor element measuring and outputting the acceleration when the driving signal is input; a bias circuit outputting a bias signal for driving the acceleration sensor element; a second detection circuit unit detecting and outputting an output signal from the acceleration sensor element; and a second processing circuit unit extracting and outputting the acceleration sensor data from the output signal when the output signal from the second detection circuit unit is input.

### BRIEF DESCRIPTION OF THE DRAWINGS

FIG. 1 is a configuration diagram of a selective motion recognition apparatus using an inertial sensor according to a first preferred embodiment of the present invention;

FIG. 2 is a detailed block configuration diagram of an angular velocity sensor of FIG. 1;

FIG. 3 is a detailed block configuration diagram of an acceleration sensor of FIG. 1;

FIG. 4 is a detailed block configuration diagram of a selection unit of FIG. 1 according to the first exemplary embodiment;

FIG. 5 is a detailed block configuration diagram of the selection unit of FIG. 1 according to a second exemplary embodiment;

FIG. 6 is a detailed block configuration diagram of a motion detection unit of FIG. 1; and

FIG. 7 is a detailed block configuration diagram of a determination unit of FIG. 1.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments according to the present invention will be described in detail with reference to the accompanying drawings.

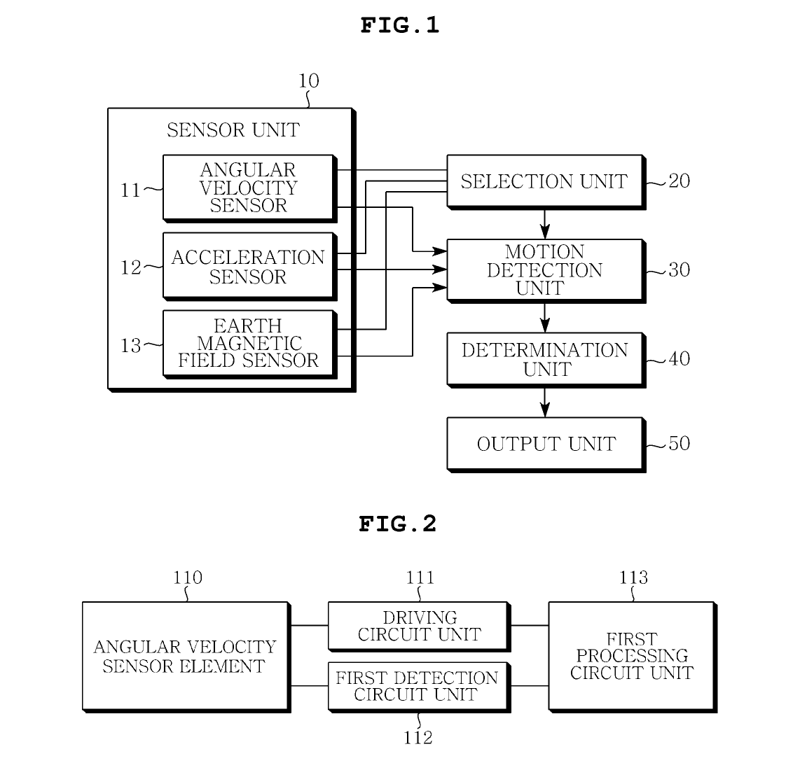

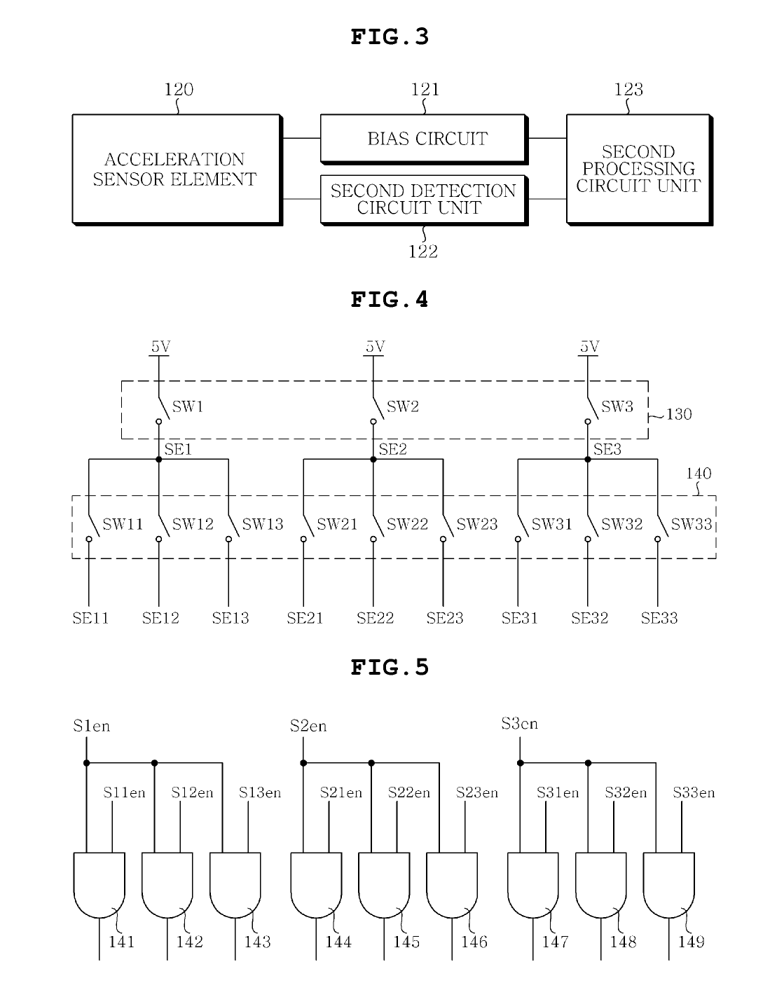

FIG. 1 is a configuration diagram of a selective motion recognition apparatus using an inertial sensor according to a first preferred embodiment of the present invention.

Referring to FIG. 1, a selective motion recognition apparatus using an inertial sensor according to a first preferred embodiment of the present invention includes a sensor unit 10, a selection unit 20, a unit motion detection unit 30, a determination unit 40, and an output unit 50.

The sensor unit 10 measures angular velocity, acceleration, and earth magnetic field according to a targeted object to output angular velocity sensor data, acceleration sensor data, and earth magnetic field sensor data.

In this case, the sensor unit 10 measures the angular velocity, the acceleration, and the earth magnetic field for each axis of multi-axis to output the angular velocity sensor data for each axis, the acceleration sensor data for each axis, and the earth magnetic field sensor data for each axis.

To this end, the sensor unit 10 includes an angular velocity sensor 11 that measures and outputs the angular velocity when periodically measuring and outputting the angular velocity or receiving a selective signal, an acceleration sensor 12 that measures and outputs the acceleration when periodically measuring and outputting the acceleration or receiving the selective signal, and an earth magnetic field sensor 13 that measures and outputs the earth magnetic field when periodically measuring and outputting the earth magnetic field or receiving the selective signal.

As shown in FIG. 2, the angular velocity sensor 11 includes an angular velocity sensor element 110 that measures and outputs the angular velocity when the driving signal is input from a driving circuit unit 111 and the driving circuit unit 111 that outputs a driving signal when periodically outputting the driving signal for driving the angular velocity sensor element 110 or receiving the selective signal.

In addition, the angular velocity sensor 11 includes a first detection circuit unit 112 that detects and outputs an output signal from the angular velocity sensor element 110 and a first processing circuit unit 113 that extracts and outputs the angular velocity sensor data from the output signal when the output signal from the first detection circuit unit 112 is input.

When the angular velocity sensor element 110 in the angular velocity sensor 11 having the above configuration uses a uniaxial angular velocity sensor element, it measures the angular velocity in a vertical direction (herein, referred to as an X axis for convenience), a left and right direction (herein, referred to as a Y axis for convenience), and a front and rear direction (herein, referred to as a Z-axis for convenience) by using three uniaxial angular velocity sensor elements to output the angular velocity sensor data for each axis and when it uses the 3-axis angular velocity sensor element, it measures the angular velocity in a vertical direction, a left and right direction, and a front and rear direction by using only the single 3-axis angular velocity sensor element to output the angular velocity sensor data for each axis.

When the driving signal is input together with an axis selection signal selecting a driving axis from the driving circuit unit 111, the angular velocity sensor element 110 drives only the selected axis to measure and output the angular velocity sensor data related to the driven axis.

To this end, the driving circuit unit 111 outputs only the driving signal when driving the angular velocity sensor element 110 or outputs the driving signal together with the axis selection signal when wanting to obtain the angular velocity related to the specific axis in the driving signal.

In this case, the first processing circuit unit 113 includes an analog/digital signal processor that converts and outputs an analog signal output by the angular velocity sensor element 110 into a digital signal, thereby making it possible to convert and output the analog signal into the digital signal.

Next, the acceleration sensor 12 includes an acceleration sensor element 120 that measures the acceleration when a bias signal is input to output the acceleration sensor data and a bias circuit 121 that outputs the bias signal when the bias signal is periodically output to the acceleration sensor element 120 and or the selective signal is input therein.

In addition, the acceleration sensor 12 includes a second detection circuit unit 122 that detects and outputs the output signal from the acceleration sensor element 120 and a second processing circuit unit 123 that extracts and outputs the acceleration sensor data from the output signal when the output signal from the second detection circuit unit 122 is input.

When the acceleration sensor element 120 in the acceleration sensor 12 having the above configuration uses a uniaxial acceleration sensor element, it measures the acceleration in a vertical direction (herein, referred to as an X axis for convenience), a left and right direction (herein, referred to as a Y axis for convenience), and a front and rear direction (herein, referred to as a Z-axis for convenience) by using three uniaxial acceleration sensor elements to output the acceleration sensor data for each axis and when it uses the 3-axis acceleration sensor element, it measures the acceleration in a vertical direction, a left and right direction, and a front and rear direction by using only the single 3-axis acceleration sensor element to output the acceleration sensor data for each axis.

When the bias signal is input together with the axis selection signal selecting a driving axis from the bias circuit 121, the acceleration sensor element 120 drives only the selected axis to measure and output the acceleration related to the driven axis.

To this end, the bias circuit 121 outputs only the bias signal when driving the acceleration sensor element 120 or outputs the bias signal together with the axis selection signal when wanting to obtain the acceleration related to the specific axis in the driving signal.

In this case, the second processing circuit unit 123 includes the analog/digital signal processor that converts and outputs the analog signal output by the acceleration sensor element 120 into a digital signal, thereby making it possible to convert and output the analog signal into the digital signal.

Meanwhile, when the earth magnetic field sensor 13, which detects and outputs the earth magnetic field, uses the uniaxial earth magnetic field sensor element, it may measure the earth magnetic field of a vertical direction (herein, referred to as an X axis for convenience), a left and right direction (herein, referred to as a Y axis for convenience), and a front and rear direction (herein, referred to as a Z-axis for convenience) by using three uniaxial earth magnetic field sensor elements and when it uses a 3-axis earth magnetic field sensor element, it uses only a single 3-axis earth magnetic field sensor element to measure the earth magnetic field of a vertical direction, a left and right direction, and a front and rear direction.

When the driving signal is input together with the axis selection signal selecting the driving axis from the selection unit 20, the earth magnetic field sensor 13 drives only the selected axis to measure and output the earth magnetic field related to the driven axis.

Next, the selection unit 20 outputs the sensor selection signal and the axis selection signal according to the selection of the user to the sensor unit 10 or the motion detection unit 30 when the user selects a type of a sensor and a type of an axis required for applications through an input unit (not shown) to inform the type of the sensor and the type of the axis required for applications.

In this case, the type of the sensor required for applications by the user may be the angular velocity sensor, the acceleration sensor, the earth magnetic field sensor or the combination of each sensor, for example, a combination of the angular velocity sensor and the acceleration sensor, a combination of the angular velocity sensor and the earth magnetic field sensor, a combination of the acceleration sensor and the earth magnetic field sensor, and a combination of the angular velocity sensor, the acceleration sensor, and the earth magnetic field sensor.

The type of the axis required for applications by the user may be any one of 3 axes or a combination thereof, for example, the X axis, the Y axis, the Z axis or a combination thereof, for example, a combination of the X axis and the Y axis, a combination of the X axis and the Z axis, a combination of the Y axis and the Z axis, and a combination of the X axis, the Y axis, and the Z axis.

In the present invention, the type of the axis may individually be selected according to the type of the sensor, for example, the angular velocity sensor may be selected, the combination of the X axis and the Y axis or the combination of the X axis and the Z axis, etc., may be selected.

As shown in FIG. 4, the selection unit 20 is configured to include a sensor type selection end 130 that includes selection switches SW1 to SW3 according to the type of each sensor to output sensor selection signals SE1 to SE3 selecting the sensor type and an axis type selection end 140 that includes axis type selection switches SW11 to SW13, SW21 to SW23, and SW31 to SW33 to output axis selection signals SE11 to SE13, SE21 to SE23, and SE31 to SE33 selecting the axis type.

The first switch SW1 in the sensor type selection end 130 is a switch selecting the angular velocity sensor, the second switch SW2 is a switch selecting the acceleration sensor, and the third switch SW3 is a switch selecting the earth magnetic field sensor.

An eleventh switch SW11, a twenty-first switch SW21, a thirty-first switch SW31 of the axis type selection end 140 are a switch that selects the angular velocity of the X axis, the acceleration of the X axis, and the earth magnetic field of the X axis.

In addition, a twelfth switch SW12, a twenty-second switch SW22, a thirty-second switch SW32 of the axis type selection end 140 are a switch that selects the angular velocity of the Y axis, the acceleration of the Y axis, and the earth magnetic field of the Y axis.

In addition, a thirteenth switch SW13, a twenty-third switch SW23, a thirtieth-three switch SW33 of the axis type selection end 140 are a switch that selects the angular velocity of the Z axis, the acceleration of the Z axis, and the earth magnetic field of the Z axis.

The selection unit 20 having the above configuration switches the selection switches SW1 to SW3 for each sensor type of the sensor type selection end 130 to output the sensor selection signal selecting the sensor type and switches the axis type selection switches SW11 to SW13, SW21 to SW23, and SW31 to SW33 of the axis type selection end 140 to output the axis selection signal for each sensor selecting the axis type for each sensor.

Meanwhile, unlike the above-mentioned description, as shown in FIG. 5, the selection unit 20 may be configured to include axis selection AND circuits 141 to 149 for each of a plurality of sensor types having as the input a sensor enable signal input end receiving sensor enable signals S1en to S3en selecting the sensor type and an axis enable signal input end receiving axis selection enable signals S11en to S13en, S21en to S23en, and S31en to S33en capable of selecting the axis type for each sensor type.

The first sensor enable signal S1en in the sensor enable signal is a signal selecting an angular velocity sensor, the second sensor enable signal S2en in the sensor enable signal is a signal selecting the acceleration sensor, and the third sensor enable signal S3en in the sensor enable signal is a signal selecting the earth magnetic field sensor.

The axis selection enable signal S11en for each eleventh sensor of the axis enable signal input end is a signal selecting the angular velocity of the X axis, the axis selection enable signal S12en for each twelfth sensor is a signal selecting the angular velocity of the Y axis, and the axis selection enable signal S13en for each thirtieth sensor is a signal selecting the angular velocity of the Z axis.

In addition, the axis selection enable signal S21en for each twenty-first sensor of the axis enable signal input end is a signal selecting the acceleration of the X axis, the axis selection enable signal S22en for each twenty-second sensor is a signal selecting the acceleration of the Y axis, and the axis selection enable signal S23en for each twenty-third sensor is a signal selecting the acceleration of the Z axis.

In addition, the axis selection enable signal S31en for each thirty-first sensor of the axis enable signal input end is a signal selecting the earth magnetic field of the X axis, the axis selection enable signal S32en for each thirty-second sensor is a signal selecting the earth magnetic field of the Y axis, and the axis selection enable signal S33en for each thirty-third sensor is a signal selecting the earth magnetic field of the Z axis.

Meanwhile, the axis selection AND circuit 141 for each first sensor type receives the angular velocity selection signal and outputs the selection signals selecting the angular velocity of the X axis when it receives the axis selection enable signals for each sensor.

Similarly, the axis selection AND circuit 141 for each second sensor type receives the angular velocity selection signal and outputs the selection signals selecting the angular velocity of the Y axis when it receives the axis selection enable signals for each sensor.

Meanwhile, the axis selection AND circuit 143 for each third sensor type receives the angular velocity selection signal and outputs the selection signals selecting the angular velocity of the Z axis when it receives the axis selection enable signals for each sensor.

Next, the axis selection AND circuit 144 for each fourth sensor type receives the acceleration selection signal and outputs the selection signals selecting the acceleration of the X axis when it receives the axis selection enable signals for each sensor.

Similarly, the axis selection AND circuit 145 for each fifth sensor type receives the acceleration selection signal and outputs the selection signals selecting the acceleration of the Y axis when it receives the axis selection enable signals for each sensor.

Next, the axis selection AND circuit 146 for each sixth sensor type receives the acceleration selection signal and outputs the selection signals selecting the acceleration of the Z axis when it receives the axis selection enable signals for each sensor.

Further, the axis selection AND circuit 147 for each seventh sensor type receives the earth magnetic field selection signal and outputs the selection signals selecting the earth magnetic field of the X axis when it receives the axis selection enable signals for each sensor.

Similarly, the axis selection AND circuit 148 for each eighth sensor type receives the earth magnetic field selection signal and outputs the selection signals selecting the earth magnetic field of the Y axis when it receives the axis selection enable signals for each sensor.

Further, the axis selection AND circuit 149 for each ninth sensor type receives the earth magnetic field selection signal and outputs the selection signals selecting the earth magnetic field of the Z axis when it receives the axis selection enable signals for each sensor.

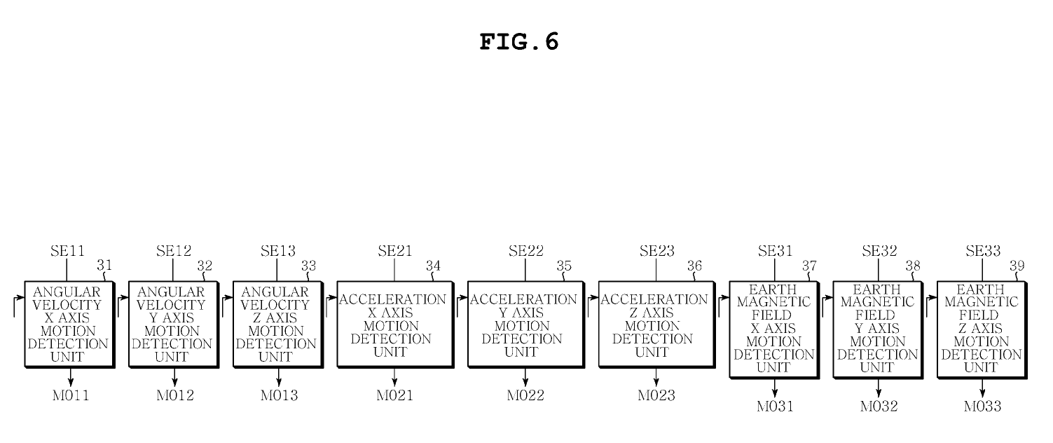

As shown in FIG. 6, the motion detection unit 30 includes an angular velocity X axis motion detector 31, an angular velocity Y axis motion detector 32, an angular Z axis motion detector 33, an acceleration X axis motion detector 34, an acceleration Y axis motion detector 35, an acceleration Z axis motion detector 36, an earth magnetic field X axis motion detector 37, an earth magnetic field Y axis motion detector 38, and an earth magnetic field Z axis motion detector 39.

The angular velocity X axis motion detector 31 detects and outputs the angular velocity data related to the X axis motion among the angular velocity data output from the angular velocity sensor when it receives the angular velocity X axis selection signal SE11 from the selection unit 20.

The angular velocity Y axis motion detector 32 detects and outputs the angular velocity data related to the Y axis motion among the angular velocity data output from the angular velocity sensor when it receives the angular velocity Y axis selection signal SE12 from the selection unit 20.

Next, the angular velocity Z axis motion detector 33 detects and outputs the angular velocity data related to the Z axis motion among the angular velocity data output from the angular velocity sensor when it receives the angular velocity Z axis selection signal SE13 from the selection unit 20.

Meanwhile, the acceleration X axis motion detector 34 detects and outputs the acceleration data related to the X axis motion among the acceleration data output from the acceleration sensor when it receives the acceleration X axis selection signal SE21 from the selection unit 20.

Meanwhile, the acceleration Y axis motion detector 35 detects and outputs the acceleration data related to the Y axis motion among the acceleration data output from the acceleration sensor when it receives the acceleration Y axis selection signal SE22 from the selection unit 20.

Next, the acceleration Z axis motion detector 36 detects and outputs the acceleration data related to the Z axis motion among the acceleration data output from the acceleration sensor when it receives the acceleration Z axis selection signal SE23 from the selection unit 20.

Meanwhile, the earth magnetic field X axis motion detector 37 detects and outputs the earth magnetic field data related to the X axis motion among the earth magnetic field data output from the earth magnetic field sensor when it receives the earth magnetic field X axis selection signal SE31 from the selection unit 20.

The earth magnetic field Y axis motion detector 38 detects and outputs the earth magnetic field data related to the Y axis motion among the earth magnetic data output from the earth magnetic field sensor when it receives the earth magnetic field Y axis selection signal SE32 from the selection unit 20.

Next, the earth magnetic field Z axis motion detector 33 detects and outputs the earth magnetic field data related to the Z axis motion among the earth magnetic field data output from the earth magnetic field sensor when it receives the earth magnetic field Z axis selection signal SE11 from the selection unit 20.

Meanwhile, the determination unit 40 combines the unit motion that is detected and output in the motion detection unit 30 to generate and output the complex motion signal.

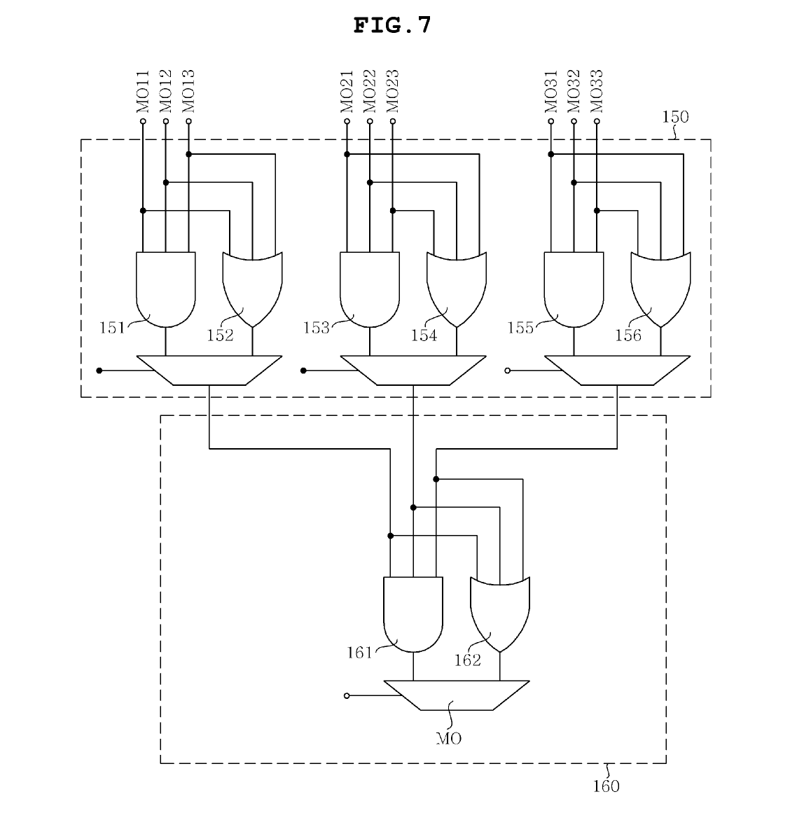

An example of the determination unit 40 is shown in FIG. 7. The determination unit 40 is configured to include a first combination unit 150 that primarily combines the unit motion detected and output in the motion detection unit 30 to generate and output a primary complex motion signal and a second combination unit 160 that secondarily combines the output of the first combination unit 150 to generate the secondary complex motion signal.

The first combination unit 150 includes a first combination AND circuit 151 that receives the output of the angular velocity X axis motion detector 31, the output of the angular velocity Y axis motion detector 32, and the output of the angular velocity Z axis motion detector 33 as an input and a first combination OR circuit 152 that receives the output of the angular velocity X axis motion detector 31, the output of the angular velocity Y axis motion detector 32, and the output of the angular velocity Z axis motion detector 33 as an input.

In this case, the first combination AND circuit 151 generates and outputs the output signal when the output of the angular velocity X axis motion detector 31, the output of the angular velocity Y axis motion detector 32, and the output of the angular velocity Z axis motion detector 33 are present and does not have the output signal when all the signals are not present.

Unlike this, the first combination OR circuit 152 generates and outputs the output signal when any one the output of the angular velocity X axis motion detector 31, the output of the angular velocity Y axis motion detector 32, and the output of the angular velocity Z axis motion detector 33 is present and does not have the output signal when all the signals are not present.

In addition, the first combination unit 150 includes a second combination AND circuit 153 that receives the output of the acceleration X axis motion detector 34, the output of the acceleration Y axis motion detector 35, and the output of the acceleration Z axis motion detector 36 as an input and a second combination OR circuit 154 that receives the output of the acceleration X axis motion detector 34, the output of the acceleration Y axis motion detector 35, and the output of the acceleration Z axis motion detector 36 as an input.

In this case, the second combination AND circuit 153 generates and outputs the output signal when the output of the acceleration X axis motion detector 34, the output of the acceleration Y axis motion detector 35, and the output of the acceleration Z axis motion detector 36 are present and does not have the output signal when all the signals are not present.

Unlike this, the second combination OR circuit 154 generates and outputs the output signal when any one of the output of the acceleration X axis motion detector 34, the output of the acceleration Y axis motion detector 35, and the output of the acceleration Z axis motion detector 36 is present and does not have the output signal when all the signals are not present.

In addition, the first combination unit 150 includes a third combination AND circuit 155 that receives the output of the earth magnetic field X axis motion detector 37, the output of the earth magnetic field Y axis motion detector 38, and the output of the earth magnetic field Z axis motion detector 38 as an input and a third combination OR circuit 156 that receives the output of the earth magnetic field X axis motion detector 37, the output of the earth magnetic field Y axis motion detector 38, and the output of the earth magnetic field Z axis motion detector 39 as an input.

In this case, the third combination AND circuit 155 generates and outputs the output signal when the output of the earth magnetic field X axis motion detector 37, the output of the earth magnetic field Y axis motion detector 38, and the output of the earth magnetic field Z axis motion detector 39 are present and does not have the output signal when all the signals are not present.

Unlike this, the third combination OR circuit 156 generates and outputs the output signal when any one of the output of the earth magnetic field X axis motion detector 37, the output of the earth magnetic field Y axis motion detector 38, and the output of the earth magnetic field Z axis motion detector 39 is present and does not have the output signal when all the signals are not present.

Next, the first combination unit 150 includes a first multiplexer (MUX11) that may select any one of the output of the first AND circuit and the output of the first OR circuit, a second multiplexer (MUX12) that may select any one the output of the second AND circuit and the output of the second OR circuit, and a third multiplexer (MUX13) that may select any one of the output of the third AND circuit and the output of the third AND circuit.

The first combination unit 150 uses the first multiplexer (MUX11) to the third multiplexer (MUX13) to output the complex motion signal of the desired combination according to the selection of the user.

Next, the second combination unit 160 of the determination unit 40 is configured to include the first AND circuit 161 that receives the output of the first multiplexer (MUX11) to the third multiplexer (MUX13) as an input, a second OR circuit 162 that receives the output of the first multiplexer (MUX11) to the third multiplexer (MUX13) as an input, and a first multiplexer (MUX21) that selects and outputs any one signal according to the selection of the user among the first AND circuit 161 and the second AND circuit.

Meanwhile, the output unit 50 receives the output of the determination unit 40 and output it to external devices, etc.

As set forth above, the preferred embodiment of the present invention can implement the complex motion recognition such as the coupling relationship of the angular velocity and the acceleration and the coupling of the angular velocity and the direction or the coupling of the acceleration and the direction in addition to the unit motion recognition such as the acceleration or the angular velocity.

Further, the preferred embodiment of the present invention operates only the sensor related to the selected motion and an axis related to the selected direction, thereby making it possible to minimize the power consumption in hardware.

In addition, the preferred embodiment of the present invention stops the operation of the sensor related to the non-selected motion and the axis related to the non-selected direction to reduce the malfunction, thereby making it possible to increase the motion recognition rate.

Moreover, the preferred embodiment of the present invention selectively sets the type of the sensor, the axis, and the combination to be appropriate for various applications, thereby making it possible to implement the optimized motion recognition.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A selective motion recognition apparatus using an inertial sensor, the selective motion recognition apparatus comprising:
an sensor unit that includes an angular velocity sensor to measure angular velocity and output angular velocity sensor data and includes an acceleration sensor to measure acceleration and output acceleration sensor data;
a selection unit that outputs a sensor selection signal selecting any one of the angular velocity sensor, the acceleration sensor, and a combination of the angular velocity sensor and the acceleration sensor; and
a motion detection unit that receives the angular velocity sensor data and the acceleration sensor data output from the sensor unit to output any one of the angular velocity sensor data, the acceleration sensor data, and a combination of the angular velocity sensor data and the acceleration sensor data according to the sensor selection signal of the selection unit.

2. The selective motion recognition apparatus as set forth in claim 1, wherein the angular velocity sensor of the sensor unit outputs the angular velocity sensor data for each axis by measuring the angular velocity for each axis of multi-axis and the acceleration sensor of the sensor unit outputs the acceleration sensor data for each axis by measuring the acceleration for each axis of multi-axis,
the selection unit outputs an axis selection signal selecting an axis of multi-axis of each of the angular velocity sensor and the acceleration sensor, and
the motion detection unit receives the angular velocity sensor data for each axis and the acceleration sensor data for each axis output from the sensor unit to output any one of the angular velocity sensor data for each axis, the acceleration sensor data for each axis, and a combination of the angular velocity sensor data for each axis and the acceleration sensor data for each axis according to the axis selection signal input from the selection unit.

3. The selective motion recognition apparatus as set forth in claim 2, wherein the selection unit includes:
a sensor type selection end including a selection switch for each sensor type to output a sensor selection signal selecting the sensor type; and
an axis type selection end including an axis type selection switch for each sensor type to output the axis selection signal selecting the axis type for the sensor selected in the sensor type selection end.

4. The selective motion recognition apparatus as set forth in claim 2, wherein the selection unit includes an axis selection AND circuit for each of a plurality of sensor types including a sensor enable signal input end receiving a sensor enable signal and an axis enable signal input end receiving an axis selection enable signal selecting the axis type for each sensor type to output the axis selection signal for each sensor.

5. The selective motion recognition apparatus as set forth in claim 1, wherein the sensor unit includes an earth magnetic field sensor to measure an earth magnetic field and output the earth magnetic field sensor data,
the selection unit outputs the sensor selection signal selecting any one of the angular velocity sensor, the acceleration sensor, the earth magnetic field sensor, and a combination thereof to the angular velocity sensor, the acceleration sensor, and the earth magnetic field sensor, and
the motion detection unit receives the angular velocity sensor data, the acceleration sensor data, and the earth magnetic field sensor data output from the sensor unit to output any one of the angular velocity sensor data, the acceleration sensor data, the earth magnetic field sensor data, and a combination thereof according to the sensor selection signal of the selection unit.

6. The selective motion recognition apparatus as set forth in claim 5, wherein the earth magnetic field sensor of the sensor unit measures the earth magnetic field for each axis of multi-axis to output the earth magnetic field sensor data for each axis,
the selection unit outputs the axis selection signal selecting the axis of multi-axis of each of the angular velocity sensor, the acceleration sensor, and the earth magnetic field sensor, and
the motion detection unit receives the angular velocity sensor data for each axis, the acceleration sensor data for each axis, and the earth magnetic field sensor data for each axis output from the sensor unit to output any one of the angular velocity sensor data for each axis, the acceleration sensor data for each axis, the earth magnetic field sensor data for each axis, and a combination of the angular velocity sensor data for each axis, the acceleration sensor data for each axis and the earth magnetic field sensor data for each axis according to the axis selection signal input from the selection unit.

7. The selective motion recognition apparatus as set forth in claim 1, further comprising a determination unit that receives any one of the angular velocity sensor data, the acceleration sensor data, and a combination of the angular velocity sensor data and the acceleration sensor data output from the motion detection unit to recognize and output the complex motion.

8. The selective motion recognition apparatus as set forth in claim 7, wherein the determination unit includes:
a first combiner receiving and primarily combining any one of the angular velocity sensor data, the acceleration sensor data, and a combination of the angular velocity sensor data and the acceleration sensor data detected and output in the motion detection unit to generate and output a primary complex motion signal; and
a second combiner secondarily combining the output of the first combiner to generate and output the secondary complex motion signal.

9. The selective motion recognition apparatus as set forth in claim 1, wherein the angular velocity sensor includes:
an angular velocity sensor element measuring and outputting the angular velocity when a driving signal is input;
a driving circuit unit outputting the driving signal for driving the angular velocity sensor element;
a first detection circuit unit detecting and outputting an output signal from the angular velocity sensor element; and
a first processing circuit unit extracting and outputting the angular velocity sensor data from the output signal when the output signal from the first detection circuit is input.

10. The selective motion recognition apparatus as set forth in claim 1, wherein the acceleration sensor includes:
an acceleration sensor element measuring and outputting the acceleration when the driving signal is input;
a bias circuit outputting a bias signal for driving the acceleration sensor element;
a second detection circuit unit detecting and outputting an output signal from the acceleration sensor element; and
a second processing circuit unit extracting and outputting the acceleration sensor data from the output signal when the output signal from the second detection circuit unit is input.
